(19) United States
(12) Patent Application Publication
(10) Pub. No.: US 2004/0189552 A1
(43) Pub. Date: Sep. 30, 2004

(54) Image display device incorporating driver circuits on active substrate to reduce interconnects

(75) Inventor: Shigeki Miyazaki, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignees: Sony Corporation, Tokyo (JP); Sony Electronics Inc., Park Ridge, NJ

(21) Appl. No.: 10/404,712

(22) Filed: Mar. 31, 2003

(51) Int. Cl. G09G 3/20; G09G 3/22

(52) U.S. Cl. 345/75.2

(57) ABSTRACT

Flat panel displays, such as field emission displays (FEDs) and plasma displays are provided having reduced through-vacuum interconnects by incorporating driver circuitry on the same substrate as the active display region of the display device. In one implementation, vacuum-sealed image display device comprises a substrate; an active display region on the substrate and including addressable rows and columns defining pixels; and driver ICs on the substrate, outputs of each driver IC coupled to the rows and columns, the drivers ICs adapted to drive the active display region to display an image. The device also comprises a vacuum envelope forming a sealed volume containing at least a portion of the substrate, the active display region and the driver ICs, the sealed volume maintained in a vacuum, the vacuum envelope defining a vacuum border. As the resolution of flat panel displays increases, reducing interconnects becomes increasingly important.

This application is related to U.S. Patent Application No.______, filed concurrently herewith, of Russ, et al., entitled “IMAGE DISPLAY DEVICE INCORPORATING DRIVER CIRCUITS ON ACTIVE SUBSTRATE AND OTHER METHODS TO REDUCE INTERCONNECTS”, Attorney Docket No. 81054/7114, the entirety of which is incorporated herein by reference.

### BACKGROUND OF THE INVENTION

1. Field of the Invention

The present invention relates generally to flat panel displays (FPDs), and more specifically to driving flat panel displays. Even more specifically, the present invention relates to driving high-resolution flat panel displays.

2. Discussion of the Related Art

Flat panel displays (FPDs), such as plasma displays and liquid crystal displays (LCDs), are becoming increasingly popular for use in display device technologies, particularly for computer monitor and television type thin displays. Furthermore, field emission displays (FEDs) are being developed for mass consumer applications.

Such flat panel displays operate by addressing many rows and columns of pixelated emitting material arranged on a thin, flat matrix. Referring to FIG. 1, in a typical vacuum-sealed FPD, such as an FED or a plasma display, the video signal is coupled to multiple driver integrated circuits (e.g., row driver IC 12 and column driver IC 14) formed on a substrate (e.g., substrates 16 and 18) having good charge carrying or mobility characteristics, such as a poly-silicon (p-Si) or a crystalline silicon (x-Si) substrate. The driver ICs are coupled to the active display region 20 which is formed on a separate substrate 22 and is vacuum-sealed within a faceplate structure in order to prevent chemical contamination, illustrated as vacuum border 24. The active display region 20 is typically formed on a glass substrate. One or more of the substrates 16, 18, 22 are fixed on a printed circuit board. Typically, the substrates 16, 18 are coupled to the substrate 22 with discrete wires 30, e.g., flexible print connectors, spanning between printed metal lines formed on the substrates. Therefore, there is a printed metal line/discrete wire/printed metal line connection coupling each output of the driver ICs 12, 14 to each row and column of the active display region 20. As is illustrated, each of the printed metal lines formed on the display substrate 22 passes through the vacuum border 24. In operation, the driver ICs 12 and 14 send the appropriate signaling to address the appropriate rows and columns of the active display region 20 to display the video signal.

Additionally, such FPDs are increasingly being used in high resolution or high definition applications. As the resolution of the device increases, the number of interconnects (i.e., discrete wires and metal lines) coupling to the active display region increases, the cost of the manufacture of the display increases and additional sources for defects are introduced. Each connection from the driver ICs to the active display region 20 controls a given column or line such that a connection defect at any point from the driver IC to the active display region 20 may result in a defective pixel. Furthermore, additional metal lines or leads passing through the vacuum seal increase the likelihood of outgassing or other compromise of the vacuum seal. Thus, it becomes increasingly difficult to reliably connect the driver ICs to the active display region 20 without compromising the display performance.

### SUMMARY OF THE INVENTION

The invention provides a flat panel display device having driver integrated circuits incorporated on the same substrate as the active display region in order to reduce the number of interconnects for the device.

In one embodiment, the invention can be characterized as a vacuum-sealed image display device comprising a substrate; an active display region on the substrate, the active display region including a plurality of addressable rows and a plurality of addressable columns defining pixels; and one or more driver ICs on the substrate, respective outputs of each driver IC coupled to respective ones of the plurality of addressable rows and the plurality of addressable columns, the one or more drivers ICs adapted to drive the active display region to display an image. The device also comprises a vacuum envelope forming a sealed volume containing at least a portion of the substrate, the active display region and the one or more driver ICs, the sealed volume maintained in a vacuum, the vacuum envelope defining a vacuum border.

In another embodiment, the invention can be characterized as a method of making a vacuum-sealed image display device comprising the steps of: providing a substrate; forming an active display region on a first portion of the substrate, the active display region having a plurality of addressable rows and a plurality of addressable columns; locating one or more driver ICs on a second portion of the substrate; forming metal lines on the substrate coupling each of the plurality of addressable rows and each of the plurality of addressable columns to a respective output of the one or more driver ICs; forming input metal lines on the substrate from each input of the one or more driver ICs to a substrate input location; and sealing the one or more driver ICs and the active display region within a vacuum on the substrate, the input metal lines passing through a vacuum border of the substrate, the metal lines coupled to each respective output of the one or more driver ICs not passing through the vacuum border

In yet another embodiment, the invention can be characterized as a method for use in a vacuum-sealed image display device comprising the steps of: receiving a serial input video signal to one or more driver ICs on a substrate via a wireline connection through a vacuum envelope of the vacuum sealed display device, the vacuum envelope sealing an active display region and the one or more driver ICs on the substrate in a vacuum, the active display region including a plurality of addressable rows and a plurality of addressable columns defining pixels; and outputting driver signaling from the one or more driver ICs to the active display region via wireline connections located within the vacuum.

### BRIEF DESCRIPTION OF THE DRAWINGS

The above and other aspects, features and advantages of the present invention will be more apparent from the following more particular description thereof, presented in conjunction with the following drawings.

FIG. 1 is a top view schematic diagram of a conventional vacuum-sealed display device in which the active display region is contained within a vacuum, for example, a field emission display or a plasma display, and illustrates the connections of the driver integrated circuits (driver ICs) to the active display region of the device.

FIG. 2 is a top view schematic diagram of a vacuum-sealed display device in which driver circuitry is formed on the same substrate as the active display region and contained within the vacuum in accordance with one embodiment of the invention.

FIG. 3 is a system-level block diagram including the display device of FIG. 2 in accordance with one embodiment of the invention.

FIG. 4 is a top view schematic diagram of one embodiment of the display device of FIGS. 2 and 3 in which each of the row and column driver integrated circuits are comprised of a cascade of multiple smaller individual driver integrated circuits.

FIG. 5 is a cross sectional view of an emitting portion of an active display region and corresponding anode portion of a field emission display in accordance with one embodiment of the invention.

FIG. 6 is a side cutaway schematic diagram of one embodiment of the vacuum-sealed display device of FIG. 2.

FIG. 7 is a side cutaway schematic diagram of another embodiment of the vacuum-sealed display device of FIG. 2 including a faceplate structure and a backplate structure having a thickness to support the vacuum without the use of spacers or wall structures, an additional vacuum volume is formed between a back surface of the active display region substrate and the backplate structure.

FIG. 8 is a system-level functional block diagram of a display device system in accordance with another embodiment of the invention.

FIG. 9 is a side cutaway schematic diagram of the vacuum-sealed display device of FIG. 8 in which other control circuitry is formed on the back surface of the active display region substrate.

FIG. 10 is a side cutaway schematic diagram of a variation of the display device of FIG. 9 in accordance with one embodiment of the invention.

FIG. 11 is a cross sectional view of an emitting portion of an active display region and corresponding anode portion of a field emission display in accordance with one embodiment of the invention.

FIG. 12 is a flowchart illustrating the steps performed in manufacturing a display device in accordance with one embodiment of the invention.

FIG. 13 is a flowchart illustrating the steps performed in the operation of a vacuum-sealed display device in accordance with one embodiment of the invention.

Corresponding reference characters indicate corresponding components throughout the several views of the drawings.

### DETAILED DESCRIPTION

The following description is not to be taken in a limiting sense, but is made merely for the purpose of describing the general principles of the preferred embodiments. The scope of the invention should be determined with reference to the claims.

In accordance with several embodiments of the present invention, a vacuum-sealed flat panel display device, such as a field emission display (FED) or a plasma display, is provided having driver integrated circuits (ICs) incorporated on the same substrate as the active display region of the display within the vacuum-sealed volume in order to reduce the number of interconnects for the device. Thus, advantageously, the number of wire interconnects passing through the vacuum seal, e.g., frit seal, is reduced. Furthermore, as the display resolution increases, the number of interconnects passing through the vacuum seal does not increase.

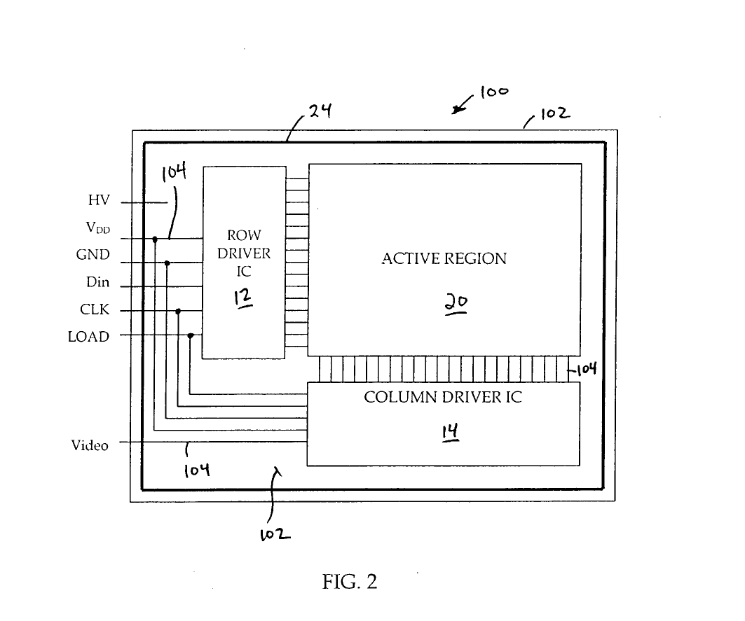

Referring first to FIG. 2, a top view schematic diagram is shown of a vacuum-sealed display device in which driver circuitry is formed on the same substrate as the active display region and contained within the vacuum in accordance with one embodiment of the invention. The image display device 100 (also referred to as a flat panel display) includes a substrate 102 having an active display region 20, a row driver integrated circuit 12 (referred to hereafter as the row driver IC 12) and a column driver integrated circuit 14 (referred to hereafter as the column driver IC 14) formed thereon. Printed metal lines 104 (also referred to as conductive leads or interconnects) are also formed on the substrate 102. The printed metal lines 104 variously couple the signal inputs to the substrate 102 to the driver ICs and couple the driver ICs 12, 14 to the active display region 20. The vacuum border 24 is defined by the boundaries of a vacuum envelope (or display structure) sealing a vacuum volume within. For example, in one embodiment, the vacuum envelope is formed by a faceplate structure sealed against the substrate 102, e.g., using frit. The volume formed within is evacuated to form the vacuum as is known in such devices.

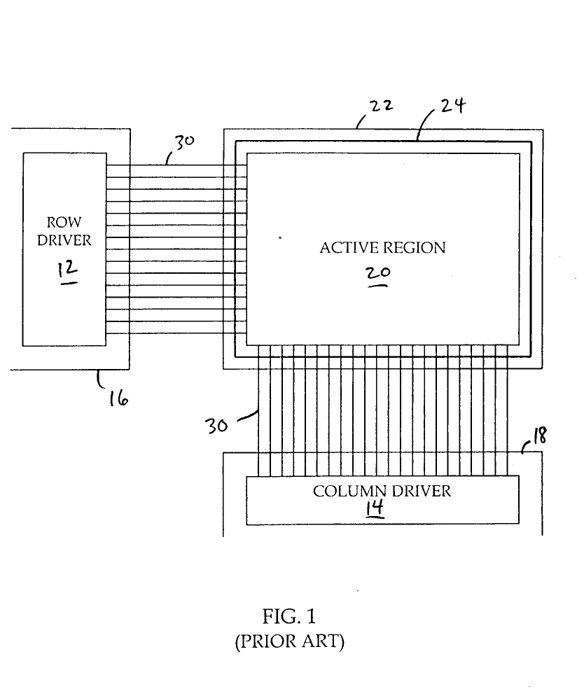

As illustrated, by incorporating the driver ICs 12, 14 on the same substrate 102 as the active display region 20, the number of wire interconnects (e.g., printed metal lines) crossing through the vacuum border 24 is dramatically reduced in comparison to that illustrated in the device of FIG. 1. As described above, each printed metal line that passes through the vacuum border 24 (e.g., passes through the frit seal) introduces a point of potential leakage of the vacuum. Advantageously, according to several embodiments of the invention, as the resolution of the display 100 increases, even though the number of printed metal lines 104 that couple between the driver ICs 12, 14 and the active display region 20 must increase, the number of wire interconnects (printed metal lines) passing through the vacuum border 24 remains the same. This is particularly advantageous in high resolution or high definition display devices where the resolution may require 1000s of printed metal lines between the driver ICs 12, 14 and the active display region 20. For example, a 1024×768 high-resolution display has 1024 addressable rows and 768 addressable columns; thus, requiring at least 1792 printed metal lines to the active display region.

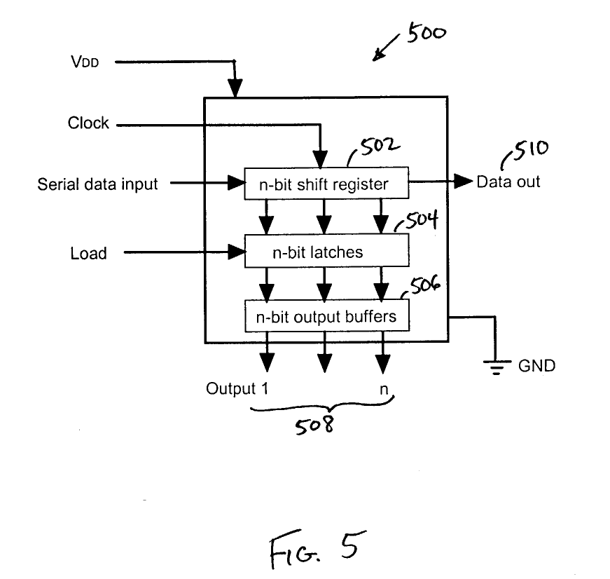

It is noted that although each of the driver ICs 12, 14 is illustrated as a single integrated circuit, each may comprise multiple driver ICs having a smaller number of outputs with each driver IC cascaded together to form the driver circuitry. One example is described in FIG. 5 below.

In accordance with several embodiments, the number of inputs for the substrate passing through the vacuum border 24 is to reduced to seven including: HV, V_{DD}, GND, Din, CLK, LOAD and VIDEO. HV is the high voltage DC to be applied to the anode of the FED or plasma display. V_{DD} is a low voltage DC for operating the driver ICs 12, 14 and driving the active display region 20. GND is the ground for all devices. Din is a logic signal for the row driver IC 12 to scan to the next row or line. CLK is the clock signal to the driver ICs 12, 14 and LOAD is a latch enable signal to operate the driver ICs according to the CLK signal. VIDEO is the serial video data stream input to the driver IC 14 which is buffered and sent to the active display region 20 a line at a time for each column. These signals are coupled to the printed metal lines 104 formed on the substrate 102 using known wireline connections, such as flexible print connectors.

In comparison to traditional FEDs, the multiple metal lines from the driver ICs 12, 14 passing through the vacuum border 24 are replaced by the video input signal (VIDEO) and the various signals to operate the driver ICs. Thus, hundreds, possibly thousands of printed metal lines are reduced to a very small number, in this embodiment, seven.

In known, vacuum-sealed displays, the substrate 102 is a bulk glass substrate. In order to couple the driver ICs 12, 14 to the substrate 102, in one embodiment, discrete driver ICs, prefabricated on a p-Si and x-Si substrate are mounted (e.g., bonded or adhered) to a periphery portion of the substrate 102, the wireline connections to the driver ICs 12, 14 implemented with printed metal lines.

In an alternative embodiment, the driver ICs 12,14 are formed on the substrate 102. However, since driver ICs should be formed on a poly-Silicon (p-Si) or crystalline-Silicon (x-Si) substrate having good mobility, a layer of silicon having poor mobility characteristics (e.g., amorphous silicon (a-Si)) is formed on the substrate 102. Since the substrate has a layer of poor mobility silicon formed thereon, the a-Si substrate is still conducive to the formation of the active display region 20. Next, a portion of the a-Si substrate 102 (e.g., the periphery portion) upon which the driver ICs 12, 14 are to be formed is laser annealed. As is well known in the art, such laser annealing turns the treated portion of the a-Si substrate into a p-Si substrate having good mobility characteristics. Thus, after annealing, the driver ICs 12, 14 may be formed on the same substrate 102 as the active display region 20. Thus, a portion of the a-Si substrate is treated to provide a substrate layer that is conducive to the formation of the driver ICs 12, 14. Accordingly, the active display region 20 is formed on the a-Si portion of the substrate 102, while the driver ICs 12, 14 are formed on the laser annealed p-Si portion of the substrate 102.

The mounting process and particularly the forming process (including the laser annealing process) introduce additional steps in the manufacturing process which in low resolution devices, introduces complexity and cost into the manufacturing process. However, as the resolution increases, the cost of the additional step becomes less than the benefit achieved and cost saved by the requiring fewer discrete wires (flexible print connectors) and the decreased likelihood of failure of a compromise of the vacuum seal. For example, in one embodiment, such additional processing becomes cost effective above VGA resolution, e.g., resolutions of 1024×768 and 1280×1024. For example, if a display device requires 2000 connections between the driver ICs 12, 14 and the active display region 20, instead of using 2000 discrete wires to connect each output of the driver ICs 12, 14 to the active display region 20 located on separate substrates 16/18 and 22, the driver ICs 12, 14 and active display region 20 are located on the same substrate 102 and lithography is used to pattern the interconnects on the substrate 102. Thus, all connections between the driver ICs 12, 14 and the active display region 20 are solid state. Furthermore, fewer printed metal lines pass through the vacuum border 24 (i.e., pass through the frit seal), which results in less opportunity to compromise the integrity of the vacuum seal.

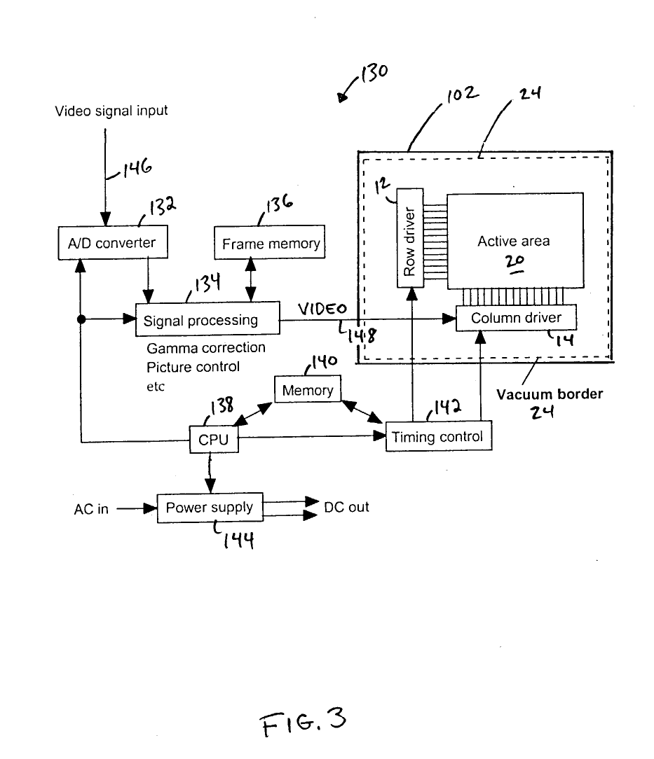

Referring next to FIG. 3, a system-level block diagram is shown including the display device of FIG. 2 in accordance with one embodiment of the invention. The system 130 includes the image display device 100, an A/D converter 132, a signal processor 134, a frame memory 136, a central processing unit 138 (hereinafter referred to as CPU 138), a memory 140, a timing control circuit 142 and a power supply 144.

In operation, an input video signal 146 to be formatted for display on the image display device 100 is digitized at the A/D converter 132, then processed (e.g., picture control and gamma correction and other known processes) by the signal processor 134. It is noted that an A/D converter 132 may not be required if the input video signal 146 is already in digital format. The frame memory 136 is used to buffer and store frames of the video signal for the signal processor 134. The output of the signal processor 134 is the video display input signal 148, i.e., the VIDEO input of FIG. 3, and is coupled to the column driver IC 14. The timing control circuit 142 provides the timing signaling, such as a clock (CLK) and other logic signals (e.g., LOAD, Din) to operate the driver ICs 12 and 14. The CPU 138 utilizes the memory 140 and controls the operation of the A/D converter 132, the signal processor 134 and the timing control circuit 142. The power supply 144 provides the high voltage (HV) to be coupled to the anode of the display device 100 and the low voltage (V_{DD}) to power the driver ICs 12, 14. In this example, the power supply 144 converts an input AC voltage to the appropriate DC output voltages. The individual components of the system 130 and their manufacture and operation are well known in the art. It is noted that not all connections are illustrated (e.g., the power and ground connections to the devices); however, such connections are well known in the art.

In contrast to known image display devices requiring a vacuum-sealed active display region, in accordance with several embodiments of the invention, the driver ICs 12, 14 are located on (e.g., premade and mounted on or formed on) the same substrate 102 as the active display region 20 is formed. Thus, as can be seen and as described more specifically with reference to FIG. 3, the number of wire leads crossing the vacuum border 24 is significantly reduced. That is, there are fewer physical connections passing through the frit seal. Since every printed metal line passing through the vacuum border represents a potential leakage location, with fewer connections passing through the seal, there are fewer potential leakage locations.

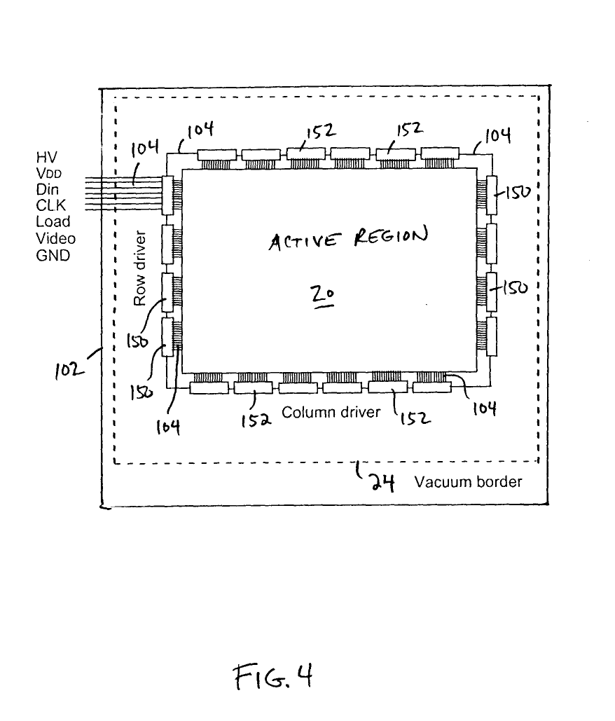

Referring next to FIG. 4, in one implementation, each of the row and column driver ICs are actually comprised of a cascade of multiple smaller individual driver ICs, e.g., row driver ICs 150 and column driver ICs 152. Each of the driver ICs 150 and 152 couple to and operate respective lines or columns of the active display region 20. Again, the number of patterned metal lines passing through the vacuum border 24 is reduced.

Referring next to FIG. 5, a functional block diagram is shown of one embodiment of a column driver IC, which may be implemented in any of the display devices described herein. The column driver IC 500 includes an n-bit shift register 502, n-bit laches 504 and n-bit output buffers 506. Inputs are V_{DD} to power the driver IC 500, Clock (CLK) and Serial data input (VIDEO signal 148) to the n-bit shift register 502, and LOAD to the n-bit laches 504. In operation and as is well known in the art, the VIDEO signal is serially input to the n-bit shift registers 502. According to the timing of the CLK and upon the assertion of the LOAD signal, the serial data for each column of a portion of a given entire line is buffered into the n-bit buffers 506 and output to the active display region. Thus, the output 508 is coupled to the gate lines or columns (column drive) of the display device. The data out 510 is coupled to the next column driver IC 500 in a cascade of column driver ICs, such as illustrated in FIG. 4.

It is noted that the row driver ICs (such as implemented within row driver IC 12) are similar to the column driver ICs 500; however, the serial data input (VIDEO) is replaced by the Din signal. The Din and CLK signals operate to cause line scanning from row to row. The output 508 is an output to activate (apply a voltage) to at least a portion of a given row.

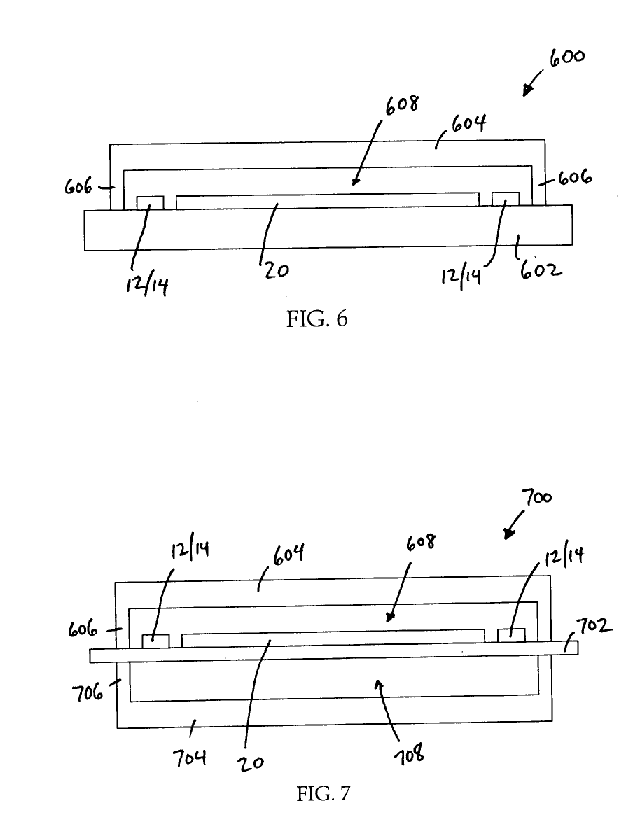

Referring next to FIG. 6, a side cutaway schematic diagram is shown of one embodiment of the vacuum-sealed display device of FIG. 2. In this view, a display structure or vacuum envelope including a faceplate structure 604 and a substrate 602 contain the active components and defines the vacuum border. The substrate 602 forms a backplate of the display device 600. That is, the substrate 602 is structurally rigid, thick glass back plate including a layer of silicon (not illustrated) upon which the active display region 20 and the driver ICs 12, 14 are located. A faceplate structure 604 is illustrated having periphery edges 606 (also referred to as the skirt of the faceplate structure) that meet with the substrate 602 proximate its periphery. As is known, an anode and phosphor materials are formed on the interior surface of the faceplate structure 604. A layer of frit (not shown) seals the faceplate structure 604 to the substrate 602 at the periphery edge portion 606 to seal the vacuum within. Thus, volume 608 sealed within the substrate 602 and the faceplate structure 604 is maintained in a vacuum. The printed metal lines that pass through the vacuum border are formed on the top surface of the substrate 602. Again, the driver ICs 12, 14 are mounted or formed on the same substrate 602 as the active display region 20 and are sealed within the volume 608.

It is noted that depending on the thickness of the substrate 602 and the faceplate structure 604, spacers or other wall-like structures may be formed on the active display region 20 in order to maintain a uniform separation between the active display region 20 and the anode/phosphors of the faceplate structure 604 across the dimensions of the display device in the presence of the vacuum. However, in other embodiments, the thickness of the substrate 602 and the faceplate structure 604 may be designed such that the faceplate structure 604 and the substrate 602 support themselves across the dimensions of the display without requiring spacers or walls. For example, the thickness of the faceplate structure 604 and the substrate 602 are each sufficient to prevent deformation of the faceplate structure and the substrate across the dimensions of the faceplate structure and the substrate due to the vacuum such that spacers are not needed in order to maintain a uniform separation between the active display region on the substrate and an anode of the faceplate structure. One example of such a thick glass display device is described in U.S. patent application Ser. No. 10/306,172, filed Nov. 27, 2003, by Russ, et al., entitled “SPACER-LESS FIELD EMISSION DISPLAY”, which is incorporated in its entirety herein by reference.

Referring next to FIG. 7, a side cutaway schematic diagram is shown of another embodiment of the vacuum-sealed display device of FIG. 2 including a faceplate structure 604 and a backplate structure 704 having a thickness to support the vacuum without the use of spacers or wall structures, an additional vacuum volume is formed between a back surface of the active display region substrate 702 and the backplate structure 704. In this embodiment of the display device 700, the substrate 702 (also referred to as the middle plate) is sandwiched between the faceplate structure 604 and the backplate structure 704. Thus, the faceplate structure 604, the backplate structure 704 and the substrate 702 form the vacuum envelope. Similar to the faceplate structure 604, the backplate structure 704 seals to a surface of the substrate 702 at its periphery portion 706, e.g., using a layer of frit (not shown). Thus, the substrate 702 sticks out of the faceplate structure 602 and the backplate structure 704, the printed metal lines passing through the frit seal on the top surface of the substrate 702.

Also noted in this embodiment, an additional volume 708 is formed between the bottom surface of the substrate 702 and the backplate structure 704. Preferably, the additional volume 708 is continuous with the volume 608. For example, there are perforations or breaks in the substrate 702 connecting the volumes 608 and 708. This allows for a larger ratio of volume to surface area of the active display region, such that the likelihood that contaminants within the volume 608/708 will stick at a portion of the active display region 20 is reduced. Furthermore, this allows getter material to be located in the volume 708 for improved gettering. Furthermore, in preferred form, the faceplate structure 604 and the backplate structure 704 have a thickness designed to withstand atmospheric pressure without requiring spacers or other wall structures to maintain uniform separation between the plates. That is, the thickness of the faceplate structure 604 and the backplate structure 704 are each sufficient to prevent deformation of the faceplate structure and the backplate structure across the dimensions of the faceplate structure and the backplate structure due to the vacuum such that spacers are not needed in order to maintain a uniform separation between the active display region and an anode of the faceplate structure. Such features and advantages are further described in U.S. patent application Ser. No. 10/306,172, as incorporated herein by reference above.

Again, since the driver ICs 12, 14 are implemented within the vacuum envelope in the devices of FIGS. 6 and 7, the number of wire interconnections passing through the vacuum envelope are significantly reduced, resulting in a greater integrity of the vacuum seal and lower manufacturing costs as resolution increases.

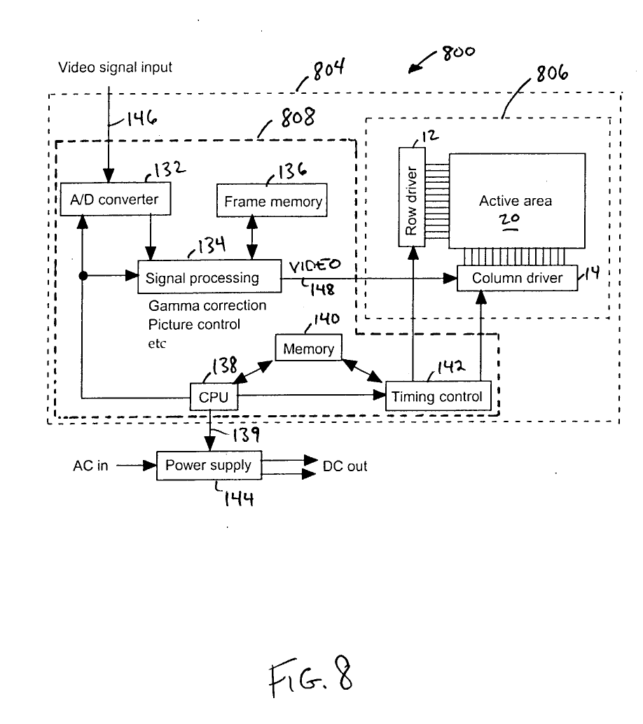

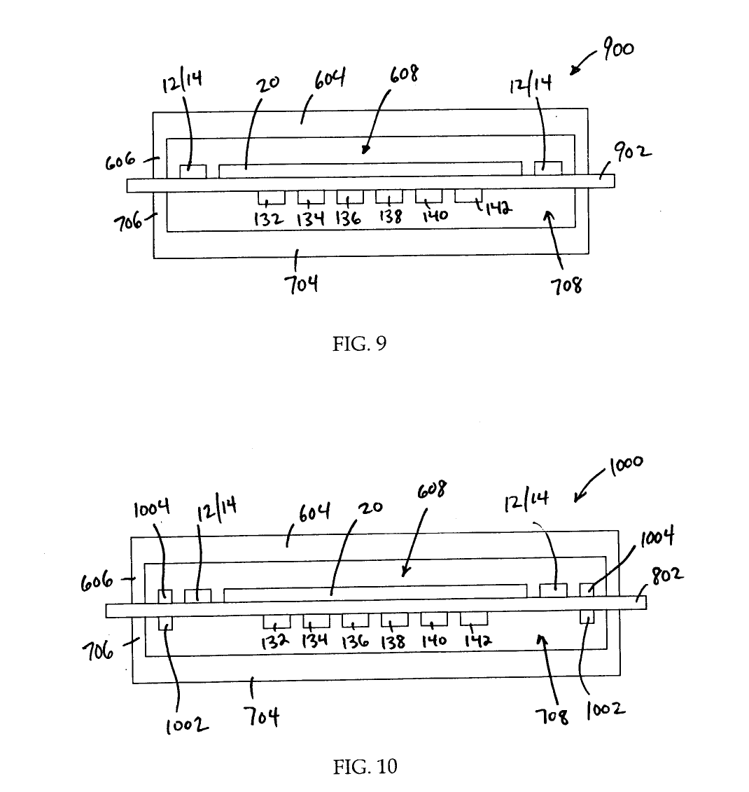

Referring next to FIG. 8, a system-level functional block diagram of a variation of the display device of FIG. 3 is illustrated in which other control circuitry is located (e.g., mounted or formed) on the back surface of the active display region substrate. Concurrent reference is made to FIG. 9, which illustrates a side cutaway schematic diagram the vacuum-sealed display device of FIG. 8. In this variation of the display device 700, the display device 800 includes additional circuitry on the back surface of a substrate 802. According to different embodiments, one or more of the following control circuits are located (e.g. mounted or formed) on the back surface: the A/D converter 132, the signal processor 134, the frame memory 136, the CPU 138, the memory 140 and the timing control 142. In one embodiment, one or more of the discrete driver ICs and discrete control circuits premade on a p-Si or x-Si substrate are mounted (e.g., adhered or bonded) on the top and/or bottom surfaces of the substrate 802. Similar to that described above, in an alternative embodiment, the front or top surface of substrate 802 has a layer of a-Si formed thereon and the portion of the substrate surface having the driver ICs 12, 14 has been laser annealed to a p-Si layer having good mobility characteristics. The back surface of the substrate 802 also has an a-Si layer formed thereon and has been laser annealed to form a good mobility p-Si layer. Thus, in the alternative embodiment, the additional control circuits are formed on the p-Si back surface of the substrate. Thus, rather than implementing the control circuitry on one or more separate substrates outside of the vacuum border 804, the control circuitry is mounted or formed on the back surface of the substrate 802 and is sealed within the vacuum border 804.

Dashed line 806 represents the components located (mounted or formed) on the front or top surface of the substrate 802, while the dashed line 808 represents the components located (mounted or formed) on the back surface of the substrate 802. The vacuum border 804 includes the components within dashed lines 806 and 808. In this embodiment, the number of wire leads or printed metal lines passing through the vacuum border 804 into the vacuum envelope is further reduced since the only metal lines required to pass through the vacuum border 804 are HV, the preprocessed video signal input 146, and a control signal 139 from the CPU 138 to the power supply 144.

It is noted that the printed metal lines crossing from the back surface of the substrate 802 to the front surface of the substrate (i.e., the VIDEO signal 148 and the timing control signals from the timing control 142) must couple from the back to the front surface of the substrate 802. In one embodiment, electrical conductors may be formed to pass the signaling through the substrate 802. In another embodiment, holes or apertures are formed near the periphery of the substrate 802 within the vacuum border and the leads are “wrapped around” from the back to the front surface.

In another embodiment illustrated in FIG. 10, the signaling from the control circuitry may be wirelessly transmitted through the substrate 802. For example, one or more transmitting devices 1002 are coupled to the signal processor 134 and the timing control 142 and transmit the signaling through the substrate 802 to one or more suitable receiving devices 1004. The receiving device(s) 1004 are coupled to the driver ICs 12,14 and wirelessly receive the signaling from the transmitting device(s) 1002. The transmitting device(s) 1002 and the receiving device(s) 1004 may be mounted or formed on the substrate similar to that described herein. Depending on the embodiment, each transmitting device 1002 may be an optical transmitter (e.g., LED, laser) or a radio frequency (RF) transmitter. Likewise, each receiving device 1004 may be a suitable optical or RF receiver. In the embodiments of FIG. 10, advantageously, wireline connections are not necessary from the back surface of the substrate 802 to the front surface of the substrate 802. However, depending on the power requirements of the transmitting device(s) 1002 and receiving device(s) 1004, additional printed metal lines providing the appropriate power may pass through the vacuum border 804.

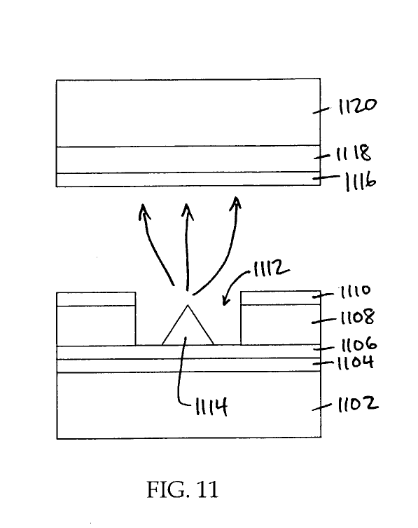

Referring next to FIG. 11 is a cross sectional view of an emitting portion of an active display region and corresponding anode of a field emission display. A cathode electrode 1104 is formed on a substrate 1102 (e.g., a glass substrate or as described above, a glass substrate having a layer of a-Si (not shown) formed thereon). A resistive layer 1106 is formed on the cathode electrode 1104. A dielectric layer 1108 separates the gate electrode 1110 from the cathode electrode 1104 and the resistive layer 1106. As is known, a well or aperture 1112 is formed in the gate electrode 1110 and the dielectric layer 1108 and an electron emitting material 1114 (e.g., a carbon emitter) is deposited in the aperture 1112. Upon the application of a voltage potential difference between the cathode electrode 1104 and the gate electrode 1110 by applying an appropriate drive voltage to the cathode electrode 1104 (e.g., from the row driver IC 12) and the appropriate drive voltage to the gate electrode 1110 (e.g., from the column driver IC 14), an electric field is created in the aperture 1112 which causes the release of electrons from the emitting material 1114. Additionally, the high voltage HV applied to an anode 1116 accelerates the electron emission toward phosphor 1118 material formed on the faceplate structure 1120. It is noted that each cathode electrode 1104 generally extends as a linear row across the active display region, while each gate electrode 1110 extends as a linear column across the active display region. The gate electrodes 1110 are generally perpendicular to the cathode electrodes 1104 and are electrically separated from each by the dielectric layer 1108. Each cathode electrode and each gate electrode couples to a respective output of the driver ICs 12,14.

Although the basic structure for an FED is illustrated, it should be understood that the inventive concepts equally apply to plasma displays and other display devices in which the active display region is required to be sealed within a vacuum.

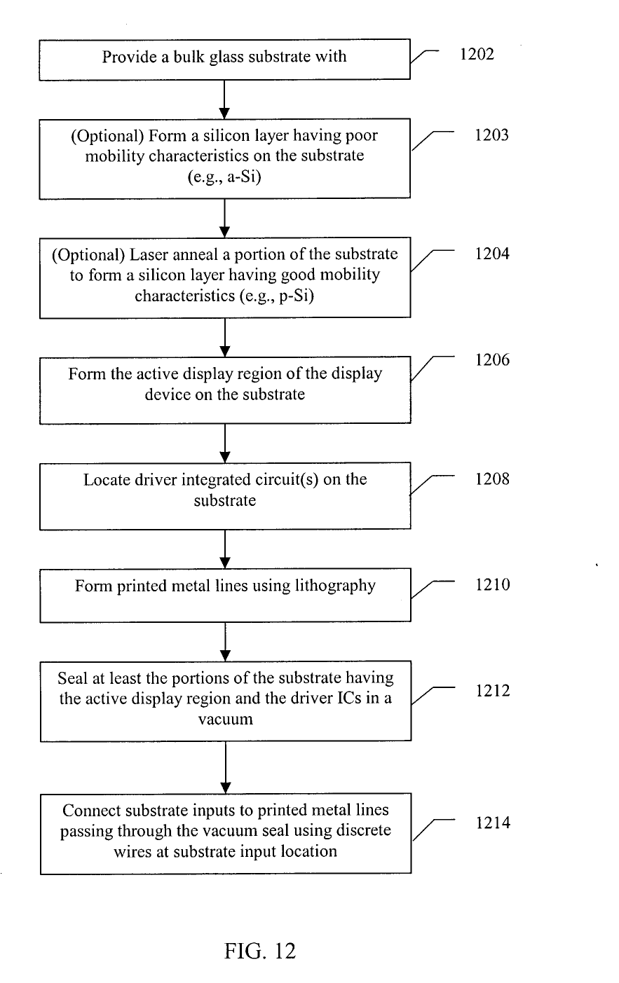

Referring next to FIG. 12, a flowchart is shown illustrating the steps performed in manufacturing a vacuum-sealed display device in accordance with one embodiment of the invention. A display device in accordance with the above embodiments may be manufactured using known chip on glass semiconductor processing techniques. In one embodiment, a bulk material (e.g., glass) substrate 102 is provided (Step 1202). If, in one embodiment, discrete driver ICs are to be attached or mounted to the substrate, proceed to Step 1206. In alternative embodiments, if the driver ICs are to be formed on the substrate, a layer of silicon exhibiting poor mobility characteristics, e.g., an amorphous-Silicon (a-Si) layer, is formed on the substrate (Step 1203). Such process is well known in the art, e.g., through chemical vapor deposition. Next, a portion, preferably the periphery portion, of the a-Si substrate is transformed into a layer of silicon having good mobility characteristics, e.g., a p-Si layer, by laser annealing the a-Si substrate (Step 1204).

Whether the driver ICs are mounted or formed, the active display region 20 is then formed on the substrate (either bulk glass or a-Si) using the known semiconductor processes depending on the type of display (Step 1206). Next, the driver ICs 12, 14 are located on the substrate (Step 1208). In one embodiment, discrete and premanufactured driver ICs are mounted on the substrate. In another embodiment, the driver ICs are formed on the p-Si portion (laser annealed a-Si) of the substrate, e.g., using known semiconductor processing techniques. Solid state printed metal lines are formed on the substrate, for example, by using lithography techniques (Step 1210). The printed metal lines couple the outputs of the driver ICs 12, 14 to the rows and columns of the active display region 20 and couple the inputs of the driver ICs 12, 14 to substrate input locations for connection to discrete wires.

Next, the portions of the substrate including the active display region and the driver ICs are sealed in a vacuum environment (Step 1212), e.g., within a vacuum envelope. Such sealing is typically done by positioning a faceplate structure and against the substrate 102 with frit then completing the frit seal; thus, the faceplate structure and the substrate form the vacuum envelope. In embodiments including a backplate structure, the substrate having the active display region and the driver ICs is sandwiched between the frontplate structure and the backplate structure and sealed with frit; thus, the faceplate structure, the backplate structure and the substrate form the vacuum envelope. The sealed volume containing the active display region and the driver ICs is evacuated to create the vacuum. It is important to note that due to the fact that the driver ICs are typically formed of a ceramic material and the substrate for the active display region is typically a glass material, the vacuum sealing should be performed at less than 300 degrees Celsius in order to avoid problems with the substrate and the driver IC expanding at different rates. A typical vacuum seal is performed at about 400-450 degrees Celsius; however, such temperature may cause defects in the driver ICs. Thus, care should be taken to ensure that the vacuum sealing temperature corresponds to the temperature sensitivity of the components to be sealed therein. For example, in preferred embodiments, the vacuum sealing is performed at less than 300 degrees Celsius. Then, the substrate inputs (e.g., HV, V_{DD}, VIDEO, etc.) are connected to printed metal lines coupled to the inputs of the driver ICs (e.g., using flexible print connectors) at substrate input locations (Step 1214).

It is noted that there may be many individual steps to be performed in accomplishing any of the listed steps above. Furthermore, the order of steps presented in FIG. 12 is not necessarily the order in which the steps are actually performed. For example, it is understood that more than one step may be performed at the same time and the order of steps may be altered.

The exact steps in forming the active display area will vary depending on the type of display being manufactured, e.g., FED, plasma display. Specifically, in forming the active display region of an FED (Step 1206), conductive rows (cathode electrodes 1104) and driver wires (printed metal lines 104) are sputtered on the substrate out of a suitable conducting material, e.g., gold, chrome, molybdenum, platinum, etc. The cathode electrodes or rows are each coupled to the row driver IC 12. A resistive layer 1106 is then formed over the cathode lines. A layer of photosensitive dielectric 1108 or insulating material is then spin coated or formed over the substrate 102 and over portions of the cathode electrodes/resistive layer. Next, a layer of conductive gate electrode material is formed over the layer of dielectric material. Then, the gate electrode material layer and the dielectric material layer are patterned using photolithography, for example, and dry etched away to form the gate electrodes 1110 (columns) having apertures 1112. Each gate electrode or column is coupled to the column driver IC 14. The apertures 1112 are etched from the gate electrode 1110 and the insulating layer 1108 and expose the underlying resistive layer 1106. Next, the emitter material 1114 is deposited in each aperture 1112.

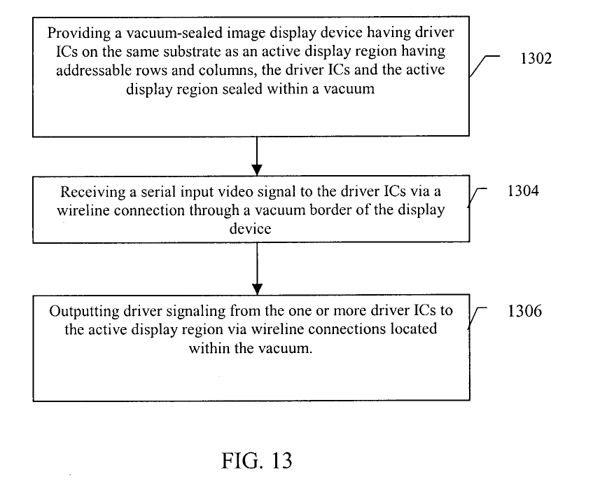

Referring next to FIG. 13, a flowchart is shown illustrating the steps performed in the operation of a vacuum-sealed display device in accordance with one embodiment of the invention. Initially, a vacuum-sealed image display device having driver ICs on the same substrate as an active display region is provided (Step 1302). The active display region includes addressable rows and columns, the driver ICs and the active display region sealed within a vacuum envelope. The driver ICs may be mounted or formed on the substrate. For example, an image display device, such as illustrated in FIGS. 2-10 may be provided. Next, a serial input video signal is received at the driver ICs via a wireline connection through a vacuum border of the display device (Step 1304). The vacuum border is defined by a vacuum envelope sealing the portion of the substrate having the driver ICs and the active display region therein. In preferred embodiments, the input video signal is received over a printed metal line passing through the vacuum border. Next, driver signaling is output from the driver ICs to the active display region via wireline connections located within the vacuum (Step 1306). Thus, the wireline connections (e.g., printed metal lines) from the driver ICs to the active display region are entirely contained within the vacuum envelope and do not pass through a vacuum border. Advantageously, the single input video signal wireline passing through the vacuum border replaces a number of wireline connections passing through the vacuum border depending on the resolution of the device, such as illustrated in FIG. 1. It is noted that these steps may be modified or added to depending on the embodiment. For example, in embodiments incorporating control circuitry within the vacuum envelope, the input video signal may be processed (e.g., by a signal processor) prior to being coupled to the driver ICs.

The foregoing presentation of the described embodiments is provided to enable any person skilled in the art to make or use the invention as claimed. While the invention herein disclosed has been described by means of specific embodiments and applications thereof, numerous modifications and variations could be made thereto by those skilled in the art without departing from the scope of the invention set forth in the claims.

What is claimed is:

1. A vacuum-sealed image display device comprising:
a substrate;
an active display region on the substrate, the active display region including a plurality of addressable rows and a plurality of addressable columns defining pixels;
one or more driver ICs on the substrate, respective outputs of each driver IC coupled to respective ones of the plurality of addressable rows and the plurality of addressable columns, the one or more drivers ICs adapted to drive the active display region to display an image; and
a vacuum envelope forming a sealed volume containing at least a portion of the substrate, the active display region and the one or more driver ICs, the sealed volume maintained in a vacuum, the vacuum envelope defining a vacuum border.

2. The device of claim 1 wherein the one or more driver ICs comprise:
one or more row driver ICs, the outputs of which are coupled to the respective ones of the plurality of addressable rows; and
one or more column driver ICs, the outputs of which are coupled to the respective ones of the plurality of addressable columns.

3. The device of claim 1 further comprising:
printed metal lines on the substrate within the vacuum envelope coupling each of the plurality of addressable rows and each of the plurality of addressable columns to a respective output of the one or more driver ICs.

4. The device of claim 3 further comprising printed metal lines on the substrate providing inputs to the substrate and coupled to inputs of the one or more driver ICs.

5. The device of claim 4 wherein the printed metal lines providing the inputs pass through the vacuum border out of the vacuum envelope.

6. The device of claim 4 wherein the inputs to the substrate coupled to the one or more driver ICs comprise a serial video signal input, power, ground and timing signals.

7. The device of claim 1 wherein the vacuum envelope comprises a faceplate structure and the substrate.

8. The device of claim 7 wherein a thickness of the faceplate structure and the substrate are sufficient to prevent deformation of the faceplate structure and the substrate across the dimensions of the faceplate structure and the substrate due to the vacuum such that spacers are not needed in order to maintain a uniform separation between the active display region and the faceplate structure.

9. The device of claim 1 wherein the vacuum envelope comprises a faceplate structure and a backplate structure, the substrate held in between the faceplate structure and the backplate structure.

10. The device of claim 9 wherein a thickness of the faceplate structure and the backplate structure are sufficient to prevent deformation of the faceplate structure and the backplate structure across the dimensions of the faceplate structure and the backplate structure due to the vacuum such that spacers are not needed in order to maintain a uniform separation between the active display region and the faceplate structure.

11. The device of claim 1 wherein the vacuum-sealed image display device comprises a field emission display.

12. The device of claim 1 wherein the vacuum-sealed image display device comprises a plasma display.

13. The device of claim 1 further comprising phosphor material coupled to a faceplate structure of the vacuum envelope.

14. The device of claim 13 further comprising:
an anode coupled to the phosphor material.

15. The device of claim 1 further comprising control circuitry on the substrate on a different surface than the one or more driver ICs.

16. The device of claim 15 wherein the control circuitry comprises:
a signal processor adapted to output a serial video input signal to the one or more driver ICs; and
a timing control circuit adapted to provide timing control signals to the one or more driver ICs.

17. The device of claim 16 wherein wireline connections couple the signal processor and the timing control circuit to the one or more driver ICs.

18. The device of claim 16 further comprising:
a transmitting device on the different surface of the substrate and coupled to the control circuitry; and
a receiving device on a surface of the substrate including the one or more driver ICs and coupled to the one or more driver ICs, the transmitting device adapted to transmit the video signal and the timing control signals to the receiving device.

19. The device of claim 1 wherein the substrate comprises a bulk substrate material having a layer of amorphous silicon having poor mobility characteristics formed thereon, the amorphous silicon layer conducive to the formation of the active display region.

20. The device of claim 19 wherein a portion of the amorphous silicon layer has been transformed to a silicon layer having good mobility characteristics by laser annealing, the one or more driver ICs formed on the transformed portion.

21. The device of claim 20 wherein the silicon layer is selected from a group consisting of poly silicon and crystalline silicon.

22. The device of claim 1 wherein the substrate comprises a bulk material substrate, the one or more driver ICs mounted on the substrate.

23. A method of making a vacuum-sealed image display device comprising:
providing a substrate;
forming an active display region on a first portion of the substrate, the active display region having a plurality of addressable rows and a plurality of addressable columns;
locating one or more driver ICs on a second portion of the substrate;
forming metal lines on the substrate coupling each of the plurality of addressable rows and each of the plurality of addressable columns to a respective output of the one or more driver ICs;
forming input metal lines on the substrate from each input of the one or more driver ICs to a substrate input location; and
sealing the one or more driver ICs and the active display region within a vacuum on the substrate, the input metal lines passing through a vacuum border of the substrate, the metal lines coupled to each respective output of the one or more driver ICs not passing through the vacuum border.

24. The method of claim 23 further comprising forming an amorphous-silicon layer having poor mobility characteristics on a surface of the substrate.

25. The method of claim 24 further comprising:
laser annealing, prior to the locating the one or more driver ICs, the second portion of the substrate to transform the amorphous-silicon layer into a charge carrying silicon layer having good mobility characteristics; and
wherein the locating step comprises:
forming the one or more driver ICs on the second portion of the substrate.

26. The method of claim 23 further comprising:
providing one or more discrete driver ICs;
wherein the locating step comprises mounting the one or more discrete drivers ICs on the substrate.

27. A method for use in a vacuum-sealed image display device comprising:
receiving a serial input video signal to one or more driver ICs on a substrate via a wireline connection through a vacuum envelope of the vacuum sealed display device, the vacuum envelope sealing an active display region and the one or more driver ICs on the substrate in a vacuum, the active display region including a plurality of addressable rows and a plurality of addressable columns defining pixels; and
outputting driver signaling from the one or more driver ICs to the active display region via wireline connections located within the vacuum.
